(19) United States
(12) Patent Application Publication
(10) Pub. No.: US 2004/0047295 A1
(43) Pub. Date: Mar. 11, 2004

(54) Method and apparatus for providing a common optical line monitoring and service channel over an WDM optical transmission system

(76) Inventor: Jay P. Morreale, (US)

Correspondence Address: MAYER, FORTKORT & WILLIAMS, PC, 251 NORTH AVENUE WEST, 2ND FLOOR, WESTFIELD, NJ, 07090, US

(21) Appl. No.: 10/618,454

(22) Filed: Jul. 11, 2003

Related U.S. Application Data
(60) Provisional application No. 60/404,611, filed on Aug. 20, 2002.

(51) Int. Cl. G06F 11/00

(52) U.S. Cl. 370/241

(57) ABSTRACT

A method is provided for monitoring the status of an optical transmission path employed in a WDM transmission system and for transmitting service data over the optical transmission path. The method begins by transmitting the service data as an optical service signal carried at a first channel wavelength over the transmission path. The method continues by monitoring status information pertaining to the transmission path by receiving an optical monitoring signal in which the status information is embodied. The optical monitoring signal is carried at the first channel wavelength over the transmission path.

### STATEMENT OF RELATED APPLICATION

This application claims the benefit of priority of U.S. Provisional Patent Application No. 60/404,611 filed Aug. 20, 2002, entitled “Optical Line Monitor and Service Channel.”

### FIELD OF THE INVENTION

The present invention relates generally to optical transmission systems, and more particularly to a method and apparatus for performing line monitoring and for transmitting service channel information over the optical transmission system.

### BACKGROUND OF THE INVENTION

A typical long-range optical transmission system includes a pair of unidirectional optical fibers that support optical signals traveling in opposite directions. An optical signal is attenuated over long distances. Therefore, the optical fibers typically include multiple repeaters that are spaced apart from one another. The repeaters include optical amplifiers that amplify the incoming, attenuated optical signals. The repeaters also include an optical isolator that limits the propagation of the optical signal to a single direction.

Optical transmission systems generally provide some mechanism for the transmission of service communications. Service communications can include, for example, telemetry signals that provide control or command signals, or status signals for equipment located within the optical fiber communication system. Examples of such signals are those indicating alarms, temperature conditions, equipment failure and the like. Service communications can also include service signals representing voice communication between maintenance personnel located at various sites within the optical fiber communication system.

One conventional method for providing service signals in optical form involves using wavelengths outside of the wavelength window that is used for carrying customer traffic. For example, some commercially available equipment uses wavelengths in the range from 1200 to 1400 nm (nanometers) to carry service signals, and wavelengths in the range from 1500 to 1600 nm to carry customer traffic. Such conventional equipment is described in U.S. Pat. No. 5,113,459, which provides for the transmission of telemetry signals at a dedicated, selected wavelength (for example, 1310 nm) in one direction on one fiber and at the same or a different dedicated, selected wavelength to transmit telemetry signals in the opposite direction using the second fiber. The service signals are typically transformed into a corresponding electrical signal in the repeaters to provide, for example, control to the optical amplifiers located therein. Accordingly, the service signals must be demultiplexed, regenerated and re-multiplexed with the customer data. In other cases the service signals only need to be transmitted between terminals, in which case demultiplexing, regenerating and re-multiplexing is not required.

In addition to providing service communications, optical transmission systems generally must also monitor the health of the system. For example, line monitoring can be used to detect faults or breaks in the fiber optic cable such as attenuation in the optical fiber and splice loss, faulty repeaters or amplifiers or other problems with the system. One line monitoring technique that is used to remotely detect faults in optical transmission systems is Optical Time Domain Reflectometry (OTDR). In OTDR, an optical pulse is launched into an optical fiber and backscattered signals returning to the launch end are monitored. In the event that there are discontinuities such as faults or splices in the fiber, the amount of backscattering generally changes and such change is detected in the monitored signals. Since backscattering and reflection also occurs from elements such as couplers, the monitored OTDR signals are usually compared with a reference record, new peaks and other changes in the monitored signal level being indicative of changes in the fiber path, normally indicating a fault. The time between pulse launch and receipt of a backscattered signal is proportional to the distance along the fiber to the source of the backscattering, thus allowing the fault to be located. In a WDM system, one wavelength is usually assigned as the OTDR channel.

In conventional optical transmission systems, the service channel and the line monitoring channel each require dedicated wavelengths that are different from one another.

### SUMMARY OF THE INVENTION

The present invention provides a method for monitoring the status of an optical transmission path employed in a WDM transmission system and for transmitting service data over the optical transmission path. The method begins by transmitting the service data as an optical service signal carried at a first channel wavelength over the transmission path. The method continues by monitoring status information pertaining to the transmission path by receiving an optical monitoring signal in which the status information is embodied. The optical monitoring signal is carried at the first channel wavelength over the transmission path.

In accordance with one aspect of the invention, the monitoring step employs OTDR.

In accordance with another aspect of the invention, the optical transmission path includes first and second unidirectional optical transmission paths having at least one repeater therein.

In accordance with yet another aspect of the invention, a probe signal is transmitted along the transmission path at the first channel wavelength.

In accordance with another aspect of the invention, the optical monitoring signal is a backscattered and reflected signal.

In accordance with another aspect of the invention, the probe signal is transmitted along the first unidirectional transmission path at the first channel wavelength, and the optical monitoring signal is a backscattered and reflected signal received along the second unidirectional optical transmission path.

In accordance with another aspect of the invention, the backscattered and reflected signal traverses an optical loopback path coupling the first and second unidirectional transmission paths.

In accordance with another aspect of the invention, the optical loopback path is located in the repeater.

In accordance with another aspect of the invention, the probe signal and the service signal are time-division multiplexed at the first channel wavelength.

In accordance with another aspect of the invention, customer-data is multiplexed with the optical service signal carried at the first channel wavelength. The customer-data is carried at one or more channel wavelengths different from the first channel wavelength.

In accordance with another aspect of the invention, a WDM optical communication system is provided. The communication system includes a transmitting terminal for transmitting customer data as an optical data signal carried at one or more channel wavelengths and service data as an optical service signal carried at a first channel wavelength different from the one or more channel wavelengths. The communication system also includes a receiving terminal and an optical transmission path optically coupling the transmitting and receiving terminals. The optical transmission path has at least one optical amplifier therein. Line monitoring equipment is provided for obtaining, at the first channel wavelength, status information pertaining to the transmission path.

In accordance with another aspect of the invention, the line monitoring equipment is an OTDR data acquisition arrangement.

In accordance with another aspect of the invention, the optical transmission path includes first and second unidirectional optical transmission paths having at least one repeater therein.

### BRIEF DESCRIPTION OF THE DRAWING

FIG. 1 shows a simplified block diagram of an exemplary wavelength division multiplexed (WDM) transmission system in accordance with the present invention.

FIG. 2 is a block diagram showing one example of an OTDR unit constructed in accordance with the present invention.

### DETAILED DESCRIPTION OF THE INVENTION

The present inventors have recognized that in many optical transmission systems it is possible to combine the service channel and the line monitoring channel into a single channel, thereby making an additional channel available for transmitting customer data. This integration is possible because the duty cycle of the line monitoring channel is generally quite low since the OTDR signal is transmitted as a series of pulses in which a subsequent pulse is not transmitted until the previous backscattered pulse is received.

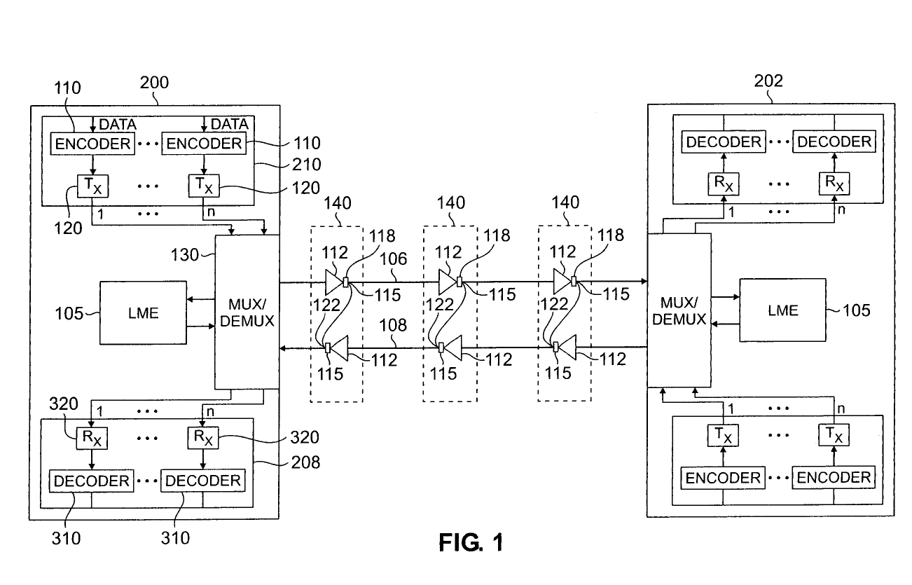

FIG. 1 shows a simplified block diagram of an exemplary wavelength division multiplexed (WDM) transmission system in accordance with the present invention. The transmission system serves to transmit a plurality of optical channels over a pair of unidirectional optical fibers 106 and 108 between terminals 200 and 202, which are remotely located with respect to one another. Terminals 200 and 202 each include transmitting and receiving units 210 and 208. The transmitting unit 210 generally includes a series of encoders 110 and digital transmitters 120 connected to a wavelength division multiplexer 130. For each WDM channel, an encoder 110 is connected to an optical source 120, which, in turn, is connected to the wavelength division multiplexer 130. Likewise, the receiving unit 208 includes a series of decoders 310, digital receivers 320 and a wavelength division demultiplexer 130. Terminals 200 and 202 also include line monitoring equipment (LME) 105 for monitoring the status of the transmission path.

Optical amplifiers 112 are located along the fibers 106 and 108 to amplify the optical signals as they travel along the transmission path. The optical amplifiers may be rare-earth doped optical amplifiers such as erbium doped fiber amplifiers that use erbium as the gain medium. As indicated in FIG. 1, a pair of rare-earth doped optical amplifiers supporting opposite-traveling signals is often housed in a single unit known as a repeater 140. While only two repeaters 140 are depicted in FIG. 1 for clarity of discussion, it should be understood by those skilled in the art that the present invention finds application in transmission paths of all lengths having many additional (or fewer) sets of such repeaters. Optical isolators 118 are located downstream from the optical amplifiers 112 to eliminate backwards propagating light and to eliminate multiple path interference.

In some embodiments of the invention the WDM transmission system is an undersea communication system in which terminals 200 and 202 are located on shore and repeaters 140 are located undersea.

LME 105 may employ any technique that is available to monitor the health and status of the transmission path. For example, LME 105 may employ OTDR. In this case, LME 105 generates an optical pulse that is launched into optical fiber 106. The optical pulse serves as the OTDR probe signal. Because optical isolators 115 located downstream from each optical amplifier 112 prevent the OTDR probe signal from being reflected and backscattered to the LME 105 on fiber 106, each repeater 140 includes a loopback path for use by the OTDR. In particular, signals generated by reflection and scattering of the probe signal on fiber 106 between adjacent repeaters enter coupler 118 and are coupled onto the opposite-going fiber 108 via coupler 122. The OTDR signal then travels along with the data on optical fiber 108. The LME 105 in terminal 202 operates in a similar manner to generate OTDR signals that are reflected and scattered on fiber 108 so that they are returned to LME 105 along optical fiber 106.

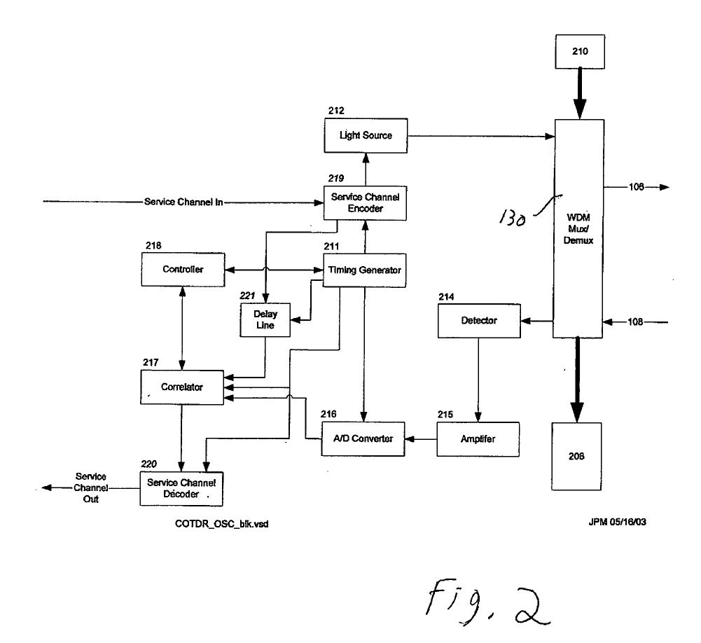

FIG. 2 is a block diagram showing one example of a conventional OTDR unit that may serve as OTDR units 105. The OTDR unit includes a timing generator 211, a light source 212, a service channel encoder 219, a detector 214, an amplifier 215, an A/D converter 216, a service channel decoder 220, a correlator 217 and controller 218. An optical pulse emitted by light source 212, which is driven by a signal from the timing generator 211, is launched into the transmission fiber through the wavelength division multiplexer 130. The reflected and backscattered OTDR signal is received by the detector 214 through the wavelength division multiplexer 130, amplified with a predetermined amplification factor by the amplifier 215 and introduced to the A/D converter 216. The A/D converter 216 samples the output of the amplifier 215 in a predetermined sampling cycle, and each of the sampled data is supplied to the correlator 217. The correlator 217 adds together the sampled data for a predetermined time and averages the data that is supplied to the controller 218. The controller 218 analyses the averaged data to monitor the transmission path for faults.

In the present invention the service data and the LME data are carried on a single channel. In the embodiment of the invention in FIG. 2, the service channel is received by the service channel encoder 219, which drives the light source 212. The light source 212 emits the service signals, which are launched into the transmission fiber through wavelength division multiplexer 130. The service signals received from wavelength division muliplexer 130 are amplified by amplifier 215, directed to correlator 217, and decoded by service channel decoder 220.

The service signals and the LME signals may be bitwise multiplexed on the channel. That is, the service signals and LME signals may be time-division multiplexed (TDM). The following analysis demonstrates how, in one embodiment of the invention, the signals may be combined so that the service signal can be transmitted while the backward-scattered LME signal is extracted.

Assuming OTDR is employed, LME 105 generates a modulated sequence of monitoring pulses such as

$$M ( t ) = {\sum }_{k = 1}^{N} {b}_{k} p ( t + kT ) .$$

Where p(t) is the pulse shape, the b's are the monitoring bits, and T is the baud rate or period between the pulses. The backscattered light contains a combination of backscattered pulses from each separate monitoring pulse. It can be represented by

$$B ( t ) = {\sum }_{k = 1}^{N} {b}_{k} q ( t + kT ) .$$

All the light from each backscattered pulse is represented by the shape q(t). If this shape can be obtained, it can be used to deduce the gain and loss status of both the fibers in the line and the amplifiers themselves.

To extract this shape from B(t), consider the Fourier transform of B(t):

$$B ( ω ) = {\sum }_{k = 1}^{N} {b}_{k} {ⅇ}^{- ⅈ k ω T} q ( ω ) .$$

The Fourier transform of B(t) can be obtained from the OTDR measurement, and the discrete Fourier transform of the bit sequence can be calculated. Then q(t) can be found by a deconvolution process:

$$q ( t ) = {F}^{- 1} [ \frac{B ( ω )}{{\sum }_{k = 1}^{N} {b}_{k} {ⅇ}^{- ⅈ k ω T}} ] .$$

The cyclically repeating sequence bₖ is chosen carefully to ensure the accuracy of this process.

Assuming that at least some of the time, the channel used for line monitoring will also be used to carry service channel information in addition to the monitoring pulses, the transmitted service and line-monitoring signal would then be given by:

$$C ( t ) = {\sum }_{k = 1}^{N / 2} {b}_{2 k} p ( t + 2 kT ) + {\sum }_{k = 1}^{N / 2} {s}_{2 m + 1} p ( t + ( 2 m + 1 ) / T ) .$$

Here the service channel data is given by the sequence sₘ, and it has been assumed for convenience that the two signals are bitwise multiplexed (i.e., time-division multiplexed). Proceeding as before, the backward scattered pulse shape q(t) can be extracted as follows:

$$q ( t ) = {F}^{- 1} [ \frac{C ( ω )}{( {\sum }_{k = 1}^{N / 2} {b}_{2 k} {ⅇ}^{- ⅈ 2 k ω T} + {\sum }_{k = 1}^{N / 2} {s}_{2 m + 1} {ⅇ}^{- i ( 2 m + 1 ) ω T} )} ] .$$

While the Discrete Fourier Transform of the line monitoring bit sequence bᵢ is known, the Fourier transform of the service channel bits sᵢ is not known. However, this latter transform can be reasonably well approximated by the Discrete Fourier Transform of a pseudo random sequence. When the service channel is encoded, means can be take to assure the validity of this approximation. That is, the service channel can be encoded as a pseudo-random signal.

Given this approximation, the backward scattered and reflected signal can be deconvolved and the backward scattered pulse shape q(t) determined, even while service channel information is being transmitted. The pulse shape q(t) can be directly interpreted as a map of both the loss and gain in the transmission path, including fiber losses and amplifier gains. Thus changes in these losses or gains can be detected.

The service channel that is provided by the system and method of the present invention can be used for the transmission of, for example, data, control and status signals, as well as voice traffic. The voice traffic carried by the service channel is used by maintenance personnel or service personnel who are working on the equipment in the optical fiber communication system. The service channel can be used to carry status information or data that relates to the equipment in the optical fiber communication system. For example, the service channel can carry data that relates to the environmental conditions at the various optical repeater sites 140, such as temperature. Alternatively, the service channel can carry status information with respect to the equipment, such as the power level, current level and signal performance information. The service channel can also carry alarm information, such as component (equipment or optical fiber) failure, or when the system switches from the protection system to the working system or from the working system to the protection system. The service channel can also carry control signals that turn on or off various pieces of equipment in the system, or change the operating mode of one or more pieces of equipment in the communication system. In some cases, such as when control signals are being transmitted, it may be necessary to transform the optical signal into an electrical signal. The data sent over the service channel is typically low speed data with each message being less than two megabits, typically on the order of 64 kilobits. In contrast, the commercial traffic that is being sent on the optical fiber communication system is on the order of 10-40 gigabits.

1. A method for monitoring the status of an optical transmission path employed in a WDM transmission system and for transmitting service data over the optical transmission path, said method comprising the steps of:
transmitting the service data as an optical service signal carried at a first channel wavelength over the transmission path; and
monitoring status information pertaining to the transmission path by receiving an optical monitoring signal in which said status information is embodied, said optical monitoring signal being carried at said first channel wavelength over the transmission path.

2. The method of claim 1 wherein the monitoring step employs OTDR.

3. The method of claim 1 wherein the optical transmission path comprises first and second unidirectional optical transmission paths having at least one repeater therein.

4. The method of claim 2 wherein the optical transmission path comprises first and second unidirectional optical transmission paths having at least one repeater therein.

5. The method of claim 1 further comprising the step of transmitting a probe signal along the transmission path at said first channel wavelength.

6. The method of claim 2 further comprising the step of transmitting a probe signal along the transmission path at said first channel wavelength, said optical monitoring signal being a backscattered and reflected signal.

7. The method of claim 4 further comprising the step of transmitting a probe signal along the first unidirectional transmission path at said first channel wavelength, said optical monitoring signal being a backscattered and reflected signal received along the second unidirectional optical transmission path.

8. The method of claim 6 wherein said backscattered and reflected signal traverses an optical loopback path coupling the first and second unidirectional transmission paths.

9. The method of claim 7 wherein said backscattered and reflected signal traverses an optical loopback path coupling the first and second unidirectional transmission paths.

10. The method of claim 9 wherein said optical loopback path is located in said repeater.

11. The method of claim 5 wherein said probe signal and said service signal are time-division multiplexed at the first channel wavelength.

12. The method of claim 7 wherein said probe signal and said service signal are time-division multiplexed at the first channel wavelength.

13. The method of claim 10 wherein said probe signal and said service signal are time-division multiplexed at the first channel wavelength.

14. The method of claim 1 wherein said service signal includes control data.

15. The method of claim 1 wherein said service signal includes status data.

16. The method of claim 1 wherein said service signal includes control and status data

17. The method of claim 14 further comprising the step of transforming the optical service signal to an electrical signal.

18. The method of claim 1 wherein the status information includes information pertaining to discontinuities in the optical transmission path that give rise to optical attenuation.

19. The method of claim 1 further comprising the step of multiplexing customer-data with the optical service signal carried at the first channel wavelength, said customer-data being carried at one or more channel wavelengths different from said first channel wavelength.

20. The method of claim 7 further comprising the step of multiplexing customer-data with the optical service signal carried at the first channel wavelength, said customer-data being carried at one or more channel wavelengths different from said first channel wavelength.

21. The method of claim 12 further comprising the step of multiplexing customer-data with the optical service signal carried at the first channel wavelength, said customer-data being carried at one or more channel wavelengths different from said first channel wavelength.

22. A method for monitoring the status of an optical transmission path employed in a WDM transmission system and for transmitting service data over the optical transmission path, said method comprising the steps of:
transmitting the service data as an optical service signal carried at a first channel wavelength over the transmission path; and
transmitting an optical probe signal for obtaining status information pertaining to the transmission path, said optical probe signal being carried at said first channel wavelength over the transmission path.

23. The method of claim 22 wherein the optical probe signal is an OTDR test signal.

24. The method of claim 22 wherein the optical transmission path comprises first and second unidirectional optical transmission paths having at least one repeater therein.

25. The method of claim 23 wherein the optical transmission path comprises first and second unidirectional optical transmission paths having at least one repeater therein.

26. The method of claim 22 further comprising the step of receiving an optical monitoring signal along the transmission path at said first channel wavelength.

27. The method of claim 23 further comprising the step of receiving an optical monitoring signal along the transmission path at said first channel wavelength.

28. The method of claim 24 further comprising the step of receiving an optical monitoring signal along the transmission path at said first channel wavelength.

29. The method of claim 28 wherein said optical monitoring signal is a backscattered and reflected signal received along the second unidirectional optical transmission path.

30. The method of claim 29 wherein said backscattered and reflected signal traverses an optical loopback path coupling the first and second unidirectional transmission paths.

31. The method of claim 30 wherein said optical loopback path is located in said repeater.

32. The method of claim 22 wherein said probe signal and said service signal are time-division multiplexed at the first channel wavelength.

33. The method of claim 28 wherein said probe signal and said service signal are time-division multiplexed at the first channel wavelength.

34. The method of claim 30 wherein said probe signal and said service signal are time-division multiplexed at the first channel wavelength.

35. The method of claim 22 wherein said service signal includes control data.

36. The method of claim 22 wherein said service signal includes status and control data.

37. The method of claim 22 wherein said service signal includes control and status data

38. The method of claim 35 further comprising the step of transforming the optical service signal to an electrical signal.

39. The method of claim 22 wherein the status information includes information pertaining to discontinuities in the optical transmission path that give rise to optical attenuation.

40. The method of claim 22 further comprising the step of multiplexing customer-data with the optical service signal carried at the first channel wavelength, said customer-data being carried at one or more channel wavelengths different from said first channel wavelength.

41. The method of claim 30 further comprising the step of multiplexing customer-data with the optical service signal carried at the first channel wavelength, said customer-data being carried at one or more channel wavelengths different from said first channel wavelength.

42. The method of claim 33 further comprising the step of multiplexing customer-data with the optical service signal carried at the first channel wavelength, said customer-data being carried at one or more channel wavelengths different from said first channel wavelength.

43. A WDM optical communication system, comprising:
a transmitting terminal for transmitting customer data as an optical data signal carried at one or more channel wavelengths and service data as an optical service signal carried at a first channel wavelength different from said one or more channel wavelengths;
a receiving terminal;
an optical transmission path optically coupling the transmitting and receiving terminals, said optical transmission path having at least one optical amplifier therein; and
line monitoring equipment for obtaining, at said first channel wavelength, status information pertaining to the transmission path.

44. The WDM optical communication system of claim 43 wherein said line monitoring equipment is an OTDR data acquisition arrangement.

45. The WDM optical communication system of claim 43 wherein the optical transmission path comprises first and second unidirectional optical transmission paths having at least one repeater therein.

46. The WDM optical communication system of claim 44 wherein the optical transmission path comprises first and second unidirectional optical transmission paths having at least one repeater therein.

47. The WDM optical communication system of claim 44 wherein said OTDR data acquisition arrangement includes a transmitter for transmitting an optical probe signal along the transmission path at said first channel wavelength.

48. The WDM optical communication system of claim 46 wherein said OTDR data acquisition arrangement includes a transmitter for transmitting a probe signal along the first unidirectional transmission path at said first channel wavelength, said optical monitoring signal being a backscattered and reflected signal received along the second unidirectional optical transmission path.

49. The WDM optical communication system of claim 48 wherein said backscattered and reflected signal traverses an optical loopback path coupling the first and second unidirectional transmission paths.

50. The WDM optical communication system of claim 49 wherein said optical loopback path is located in said repeater.

51. The WDM optical communication system of claim 47 wherein said probe signal and said service signal are time-division multiplexed at the first channel wavelength.

52. The WDM optical communication system of claim 48 wherein said probe signal and said service signal are time-division multiplexed at the first channel wavelength.

53. The WDM optical communication system of claim 50 wherein said probe signal and said service signal are time-division multiplexed at the first channel wavelength.

54. The WDM optical communication system of claim 43 wherein said service signal includes control data.

55. The WDM optical communication system of claim 43 wherein said service signal includes status data.

56. The WDM optical communication system of claim 43 wherein said service signal includes control and status data

57. The WDM optical communication system of claim 54 further comprising the step of transforming the optical service signal to an electrical signal.

58. The WDM optical communication system of claim 43 wherein the status information includes information pertaining to discontinuities in the optical transmission path that give rise to optical attenuation.

59. The WDM optical communication system of claim 43 wherein said transmitting terminal includes a multiplexer for multiplexing the customer-data with the optical service signal.

60. The method of claim 1 wherein the optical service signal is encoded as a pseudo-random signal.

61. The method of claim 22 wherein the optical service signal is encoded as a pseudo-random signal.

62. The WDM optical communication system of claim 43 wherein the transmitting terminal includes an encoder for encoding the optical service signal as a pseudo-random signal.
